(19) United States
(12) Patent Application Publication
(10) Pub. No.: US 2024/0055875 A1
(43) Pub. Date: Feb. 15, 2024

(54) SECONDARY BATTERY CAPABLE OF PREVENTING OVERCHARGE, AND CHARGING METHOD THEREOF

(71) Applicant: LG ENERGY SOLUTION, LTD., Seoul (KR)

(72) Inventor: Jun Soo PARK, Daejeon (KR)

(73) Assignee: LG ENERGY SOLUTION, LTD., Seoul (KR)

(21) Appl. No.: 18/267,059

(22) PCT Filed: Oct. 14, 2022
(86) PCT No.: PCT/KR2022/015597

§ 371 Date: Jun. 13, 2023

(30) Foreign Application Priority Data
Nov. 2, 2021 (KR) 10-2021-0149067

(51) Int. Cl. H02J 7/00; H01M 4/525; H01M 4/505

(52) U.S. Cl. CPC H02J 7/00302; H01M 4/525; H01M 4/505

(57) ABSTRACT

A secondary battery is capable of preventing overcharge. The secondary battery has a conducting wire that electrically connects a positive electrode lead and a negative electrode lead, introducing a temperature-sensitive part that changes in shape under high-temperature conditions to the negative electrode lead end side of the conducting wire, and by having a formation where the voltage between the positive electrode lead and the negative electrode lead is measured. The secondary battery can immediately halt the charging process when overcharging of the secondary battery occurs, which provides an advantage of better improving safety of the battery.

### TECHNICAL FIELD

The present invention relates to a secondary battery capable of preventing overcharge and its charging method.

This application claims the priority benefit based on Korean Patent Application No. 10-2021-0149067, filed on Nov. 2, 2021, and the entire contents of the Korean patent application are incorporated herein by reference.

### BACKGROUND OF THE INVENTION

The demand for a secondary battery as an energy source has been rapidly increasing as the technology development and demand for mobile devices increase, and among those secondary batteries, lithium secondary batteries which have high energy density and high discharge voltage are being widely used.

However, because various combustible materials are embedded in such lithium secondary batteries, it has a drawback in safety by having a risk such as heat generation and explosion due to overcharging, overcurrent, and physical external shocks. That is, when a lithium battery is exposed to high temperature or if a large amount of current flows in the lithium battery in a short time due to overcharging, external short circuit, nail penetration, local crush, etc., there can be a risk of ignition/explosion by having the battery heated up with IR heating.

Specifically, if the temperature of the battery increases, the reaction between electrolyte and an electrode gets accelerated. As a result, heat of reaction is generated which causes the temperature of the battery to be additionally increased, and this in turn accelerates the reaction between the electrolyte and the electrode. This vicious cycle causes thermal runaway, which is a phenomenon where the temperature of a battery drastically increases, and the battery may be ignited if the temperature exceeds a certain limit. In addition, the reaction between the electrolyte and the electrode yields gas that causes internal pressure of the battery to increase, and the lithium secondary battery explodes when pressure exceeds a certain limit. Such ignition/explosion risk may be the most fatal flaw of a lithium secondary battery.

Therefore, the part to be necessarily considered in a lithium secondary battery development is safety assurance. In an effort to assure safety, a safety material can be placed outside of a cell, or a material inside the cell can be used. The former includes PTC materials and CID materials that make use of temperature difference, a protection circuit that makes use of voltage difference, and a safety vent that makes use of battery internal pressure difference, while the latter includes addition of materials that may change physically, chemically, or electrochemically according to the change in the battery internal temperature or voltage.

However, the technologies known to this point each have their own problems. For example, conventional safety materials placed outside of the cell cannot provide safety when internal part of the cell is already filled up with inflammable gas due to the occurrence of issue in the battery, and CID materials can only be applied to cylindrical batteries. In addition, it is known to not serve a protective role in the case where it needs a fast response time such as external short circuit, nail penetration, local crush etc.

In addition, as one of the methods of utilizing the material inside the cell, there may be a method of adding an electrolyte or an additive that improves the safety of the electrode. While chemical safety device has an advantage of not needing additional process or space and that it can be applied to all types of batteries, it can create an issue of degradation in performance when it is added. Such materials that have been reported include a material that forms a passivity layer in the electrode and a material that increases the resistance of the electrode when the volume is expanded due to increase in temperature. However, each of them may have a problem of either reducing the battery performance by having by-products produced during the formation of passivity layer, or reducing the battery capacity by taking up too much volume inside the battery, so it is not being used as a separate measure, for not assuring complete safety.

### PATENT DOCUMENT

Japanese Patent Publication No. 2016-200539

### DESCRIPTION OF THE INVENTION

### Technical Problem

The present invention is directed to providing a secondary battery where safety issue due to overcharging is solved by detecting overcharging of the secondary battery, and halting the charging current being supplied to the secondary battery, as well as charging method thereof.

### Technical Solution

In order to achieve the above objective,

An exemplary embodiment of the present invention provides an electrode assembly having a positive electrode lead and a negative electrode lead on opposite ends of the electrode assembly; a conducting wire having a first end electrically connected to the positive electrode lead; and a voltage measurer being electrically connected to a middle of the conducting wire; and a temperature-sensitive part at a second end of the conducting wire, wherein the conducting wire electrically connects the positive electrode lead and the negative electrode lead according to temperature conditions.

Here, the temperature-sensitive part may electrically connect the positive electrode lead and the negative electrode lead by changes in shape when exposed to temperature between 70° C. and 100° C.

In addition, the temperature-sensitive part may contain a shape memory alloy comprising a Nickel-Titanium alloy.

In addition, the temperature-sensitive part may contain a bimetal comprising a first metal consisting of a Nickel-Iron alloy; and a second metal consisting of a Nickel-Manganese-Iron alloy, a Nickel-Molybdenum-Iron alloy, or a Nickel-Manganese-Copper.

In addition, the voltage measurer may measure voltage between the positive electrode lead and the negative electrode lead when the conducting wire connects to the negative electrode lead due to the change in shape of the temperature-sensitive part.

In addition, the secondary battery may contain a controller that is electrically connected to the voltage measurer and may receive voltage value measured by the voltage measurer.

The controller may halt the charging of the secondary battery if the voltage value received from the voltage measurer is greater than or equal to a predetermined value.

In addition, an exemplary embodiment of the present invention provides a charging method of a secondary battery that includes:
charging a secondary battery of claim according to the present invention by supplying electric power;
measuring a voltage by the voltage measurer when the temperature-sensitive part of the conducting wire provided in the secondary battery electrically connects to the negative electrode lead; and halting the charging of the secondary battery if the voltage value received from the voltage measurer is greater than or equal to a predetermined value.

Here, the temperature-sensitive part may electrically connect the positive electrode lead and the negative electrode lead by changes in shape when exposed to temperature between 70° C. and 100° C.

For this purpose, the temperature-sensitive part may contain a shape memory alloy comprising a Nickel-Titanium alloy.

In addition, the temperature-sensitive part may contain a bimetal comprising a first metal consisting of a Nickel-iron alloy; and a second metal consisting of a Nickel-Manganese-Iron alloy, a Nickel-Molybdenum-Iron alloy, or a Nickel-Manganese-Copper.

### Advantageous Effects

The secondary battery according to the present invention has a conducting wire that electrically connects a positive electrode lead and a negative electrode lead, introducing a temperature-sensitive part that changes in shape under high-temperature conditions to the negative electrode lead end side of the conducting wire, and having a formation where voltage between the positive electrode lead and the negative electrode lead is measured. Thereby, it can immediately halt the charging process when overcharging of the secondary battery occurs, which provides an advantage of better improving safety of the battery.

### BRIEF DESCRIPTION OF THE DRAWINGS

FIG. 1 is a top view schematically showing the component of a secondary battery according to First Embodiment of the present invention.

FIG. 2 is a front view schematically showing the secondary battery of FIG. 1.

FIG. 3 is a front view showing a state where a shape memory alloy, which is the temperature-sensitive part of FIG. 2, is transformed and connected to the negative electrode lead.

FIG. 4 is a front view schematically showing the component of secondary battery according to Second Embodiment of the present invention.

FIG. 5 is a front view showing a state where a bimetal, which is the temperature-sensitive part of FIG. 4, is transformed and connected to the negative electrode lead.

### DETAILED DESCRIPTION OF THE EMBODIMENTS

The present invention may have various modifications and various examples, and thus specific examples are illustrated in the drawings and described in detail in the detailed description. However, it should be understood that the present invention is not limited to specific embodiments, and includes all modifications, equivalents or alternatives within the spirit and technical scope of the present invention.

The term in the present invention is only used to explain a specific example and is not intended to limit to the present invention. A singular expression includes a plural expression unless the context indicates otherwise. The terms “comprise,” “include”, and “have” used herein designate the presence of characteristics, numbers, steps, actions, components or members described in the specification or a combination thereof, and it should be understood that the possibility of the presence or addition of one or more other characteristics, numbers, steps, actions, components, members or a combination thereof is not excluded in advance.

Specific exemplary embodiments of the present disclosure are described with reference to the figures. Here, it must be noted that the same elements with reference to the figures are indicated with the same symbols as far as possible. In addition, detailed explanation of any notified functions or composition that may obfuscate the present disclosure will be omitted. For the same reason, some of the elements in the figures are exaggerated or omitted or schematically illustrated.

### Secondary Battery

According to an exemplary embodiment of the present invention, comprising: an electrode assembly that has a positive electrode lead and a negative electrode lead on opposite ends; a conducting wire where its terminal electrically connects to the positive electrode lead; and a voltage measurer that is electrically connected to a middle of the conducting wire; and wherein the conducting wire contains a temperature-sensitive part being introduced into the end opposite to the one end of the conducting wire electrically connecting to the positive electrode lead, and electrically connects the positive electrode lead and the negative electrode lead according to temperature conditions.

The secondary battery according to the present invention includes an electrode assembly that each has a positive electrode lead and a negative electrode lead, and the electrode assembly is composed of a battery case that has a positive electrode, a negative electrode, and a separation membrane that is disposed between the positive electrode and the negative electrode. The positive electrode and the negative electrode included in the electrode assembly are connected to the positive electrode lead and the negative electrode lead respectively, and this electrode assembly is put into a pouch. In this case, the positive electrode lead and the negative electrode lead of the electrode assembly may be disposed to protrude outward from the pouch, and may be sealed at an edge of the pouch by thermos compression.

Here, the type of the positive electrode lead and the negative electrode lead placed on both ends of the electrode assembly is illustrated in this specification, but the present invention can apply to a type where the positive electrode lead and the negative electrode lead are placed on one end of the electrode assembly.

The positive electrode lead of electrode assembly includes a conducting wire where one end is electrically connected. The conducting wire electrically connects to the positive electrode lead, and it can be connected by stripping the end of a wire and welding it to the upper surface of the positive electrode lead. The one end of the conducting wire can be bent in order to make it parallel to the upper surface of the positive electrode lead and increase the contacting length with the upper surface of the positive electrode lead.

In addition, the conducting wire can be placed without any limitations if the location does not produce any internal short circuit between the positive electrode lead and the negative electrode lead of the electrode assembly. Specifically, the conducting wire is located on the outer surface of the electrode assembly-inserted pouch, and may be electrically connected to the positive electrode lead and the negative electrode lead protruding outward from the pouch. Also, depending on the situation, the surface of the conducting wire is insulation coated so that it can electrically connect to the positive electrode lead and the negative electrode lead on the inside of the pouch where the electrode lead is inserted.

Moreover, the conducting wire includes a temperature-sensitive part that electrically connects to the negative electrode lead by changing its shape depending on the temperature condition at the other end to the end where the positive electrode lead is electrically connected. That is, the negative electrode lead of the secondary battery may be connected to connected to the conducting wire by changing in a shape of the temperature sensitive part depending of the heat generated from the electrode assembly during overcharging of the secondary battery.

The temperature-sensitive part to electrically connect the positive electrode lead and the negative electrode lead, can cause shape change under a high temperature conditions, for example, when it is exposed to 70° C.-100° C., and specifically 80° C.-100° C. or 75° C.-95° C.

There is no special limitation to the type of such temperature-sensitive part if it can change its shape in temperature range between 70° C. and 100° C., but it can specifically be composed a shape memory alloy comprising one or more selected from the group consisting of a Nickel-Titanium alloy and a Copper-Zinc-Aluminum alloy; or a bimetal comprising a first metal consisting of a Nickel-Iron alloy, and a second metal consisting of a Nickel-Manganese-Iron alloy, a Nickel-Molybdenum-Iron alloy, a Nickel-Manganese-Copper.

According to an exemplary embodiment, the temperature-sensitive part may include a Nickel-Titanium alloy which has an excellent shape recovery capacity and a great processability.

According to another exemplary embodiment, the temperature-sensitive part may include a bimetal comprising a first metal composed of an alloy of Nickel-Iron; and a second metal composed of an alloy of Nickel-Manganese-Iron.

The voltage measurer electrically connects to the middle of conducting wire. That is, the voltage measurer can have a wire connection terminal on both ends. The voltage measurer may be positioned to be spaced apart from the electrode assembly instead of being positioned above the electrode assembly if the conducting wire has one end connect to the positive electrode lead, and the other end connect to the negative electrode lead though the temperature-sensitive part that disposed to contact the upper surface of the electrode assembly.

A secondary battery charging device is generally provided with a voltage measurer for measuring the voltage between the positive electrode and the negative electrode of the electrode assembly. Therefore, the secondary battery of the present invention can be configured by connecting a middle of the conductive wire part that is connective to respectively the positive electrode lead and the temperature-sensitive part, to the previously provided voltage measurer.

Moreover, the voltage measurer continues to measure the voltage during charging, and the measured voltage value becomes zero before the temperature-sensitive part connects to the negative electrode lead. That is, the voltage measurer is continuously driven while the secondary battery is being charged, however heat is generated due to overcharging of the secondary battery, and thus the shape of the temperature-sensitive part is deformed so that the voltage between the positive electrode lead and the negative electrode lead cannot be measured until the temperature-sensitive part is connected to the negative electrode lead, so a voltage value of zero may be obtained as a result value. In addition, when the shape of the temperature-sensitive part is deformed under a high temperature condition and gets connected to the negative electrode lead, the voltage measurer electrically connected to the middle of the conducting wire can measure the voltage between the positive electrode lead and the negative electrode lead.

In addition, the voltage measurer may be electrically connected to the controller and may transmit a measured voltage value to the controller. The controller may stop the charging of the secondary battery when a voltage higher than a predetermined value is measured by the voltage measurer.

Specifically, when charging by connecting power to the positive electrode lead and the negative electrode lead of the electrode assembly, heat is generated in the electrode assembly. Since the temperature-sensitive part is in contact with the upper surface of the electrode assembly, heat may be received by conduction. When the temperature of the temperature-sensitive part increases by receiving heat, the end part of the negative electrode lead gets thermally deformed and can be connected to the negative electrode lead at a predetermined temperature or higher. When the temperature-sensitive part is connected to the negative electrode lead, the voltage charged in the electrode assembly until then gets measured. The controller may stop the charging of the secondary battery when a voltage of a predetermined value slightly greater than zero is measured by the voltage measurer. Accordingly, this can prevent swelling or ignition of the secondary battery due to overcharging.

Here, the predetermined value means a preset value 4.0V or more, and specifically it can be 4.1V or more, 4.2V or more, 4.2 to 4.8V; or 4.2 to 4.5V.

Meanwhile, the secondary battery includes a lead-acid battery, a Nickel-Cadmium (NiCd) battery, a Nickel-metal hydrogen (Ni-MH) battery, a lithium-ion (Li-ion) battery, and a lithium-ion (Li-ion) polymer battery. According to an exemplary embodiment, the secondary battery may be a Li-ion battery. The Li-ion battery is light, has a large capacity, rarely has self-discharge, and accounts for most of the secondary battery market by having a high voltage. However, because the Li-ion battery has a possibility of explosion or ignition when it gets overcharged, there is a need for overcharge protection according to the present invention.

### Secondary Battery Charging Method

In addition, an exemplary embodiment of the present invention provides a charging method of a secondary battery that includes:
charging a secondary battery of according to the present invention by supplying with electric power;
measuring a voltage by the voltage measurer when the temperature-sensitive part of the conducting wire provided in the secondary battery electrically connects to the negative electrode lead;
halting the charging of the secondary battery if the voltage value received from the voltage measurer is greater than or equal to a predetermined value.

The secondary battery charging method according to the present invention is a method of charging the secondary battery of the present invention described above, wherein the charging is performed by supplying electric power to the secondary battery of the present invention, and the voltage measurer measures the voltage when the temperature sensitive part of the conducting wire provided in the secondary battery electrically connects to the negative electrode lead by being deformed by heat generated from the electrode assembly during overcharging.

In order for the temperature-sensitive part to electrically connect the positive electrode lead and the negative electrode lead, the temperature conditions, for example, can cause shape change when it is exposed to 70° C.-100° C., and specifically 80° C.-100° C. or 75° C.-95° C.

There is no special limitation to the type of such temperature-sensitive part if it can change its shape in temperature range between 70° C. and 100° C., but it can specifically be composed of a shape memory alloy that includes one or more kind of an alloy of a Nickel-Titanium alloy and a Copper-Zinc-Aluminium alloy; or the temperature-sensitive part may be composed of a bimetal comprising consisting of a Nickel-Iron alloy, and a second metal consisting of a Nickel-Manganese-Iron alloy, a Nickel-Molybdenum-Iron alloy, or a Nickel-Manganese-Copper.

According to an exemplary embodiment, the temperature-sensitive part may include a Nickel-Titanium alloy which has an excellent shape recovery capacity and a great processability.

According to another exemplary embodiment, the temperature-sensitive part may include a bimetal comprising a first metal composed of an alloy of Nickel-Iron and a second metal composed of an alloy of Nickel-Manganese-Iron.

In addition, the voltage measurer may send the measured voltage value to the controller through a voltage signal, and the controller may halt the secondary battery charging process if the received voltage value is above the predetermined value.

Here, the predetermined value means a preset value 4.0V or more, and specifically it can be 4.1V or more, 4.2V or more, 4.2 to 4.8V; or 4.2 to 4.5V.

In addition, the secondary battery includes a lead-acid battery, a Nickel-Cadmium (NiCd) battery, a Nickel-metal hydrogen (Ni-MH) battery, a lithium-ion (Li-ion) battery, and a lithium-ion (Li-ion) polymer battery. According to an exemplary embodiment, the secondary battery may be a Li-ion battery. The Li-ion battery is light, has a large capacity, rarely has self-discharge, and accounts for most of the secondary battery market by having a high voltage. However, because the Li-ion battery has a possibility of explosion or ignition when it gets overcharged, there is a need for overcharge protection according to the present invention.

### DETAILED DESCRIPTION OF THE EMBODIMENTS

The following description explains the secondary battery according to the present invention, and the various forms of charging methods of the secondary battery by referring to the figures.

### First Embodiment

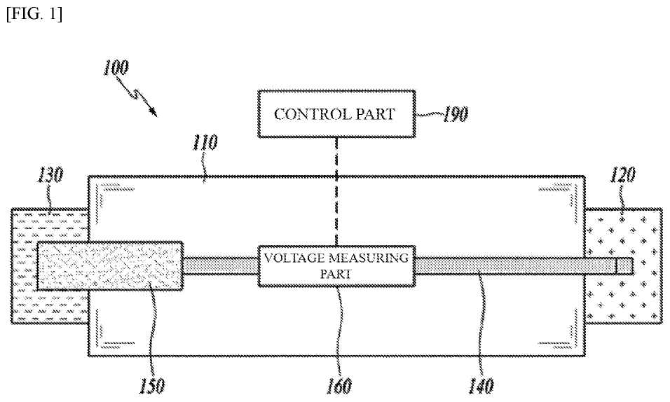

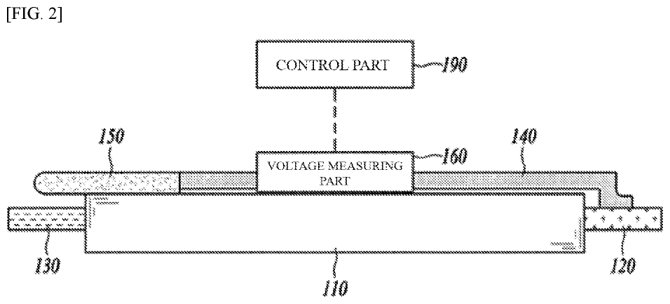

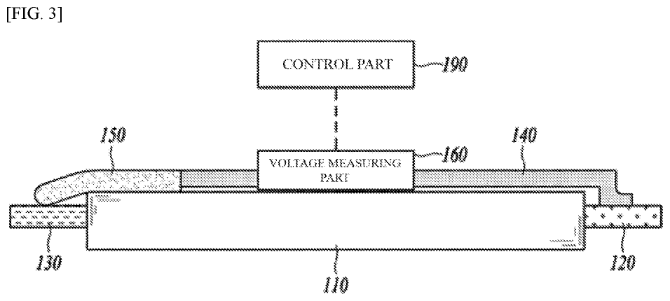

FIG. 1 is a top view schematically showing the composition of the secondary battery according to First Embodiment of the present invention, FIG. 2 is a front view schematically showing the secondary battery of FIG. 1, and FIG. 3 is a front view showing a state where a shape memory alloy, which is the temperature-sensitive part of FIG. 2, is transformed and connected to the negative electrode lead.

The secondary battery 100 according to First Embodiment of the present invention includes an electrode assembly 110 that has a positive electrode lead 120 and a negative electrode lead 130 on both ends, a conducting wire 140 where one end electrically connects to the positive electrode lead, a temperature-sensitive part 150 including a shape memory alloy that electrically connects to the other end of the conducting wire that is opposed to the end electrically connected to the positive electrode lead and at least a part of it contacts with the electrode assembly 110, a voltage measurer 160 that electrically connects to the middle of the conducting wire, and a controller 190 that halts the electrode assembly 110 from charging by measuring voltage value greater than the predetermined value when the temperature-sensitive part 150 that includes the shape memory alloy changes the shape and connects to the negative electrode lead 130.

Here, the positive electrode lead 120 and the negative electrode lead 130 are located on both ends of the electrode assembly 110, and the conducting wire 140 electrically connects to the positive electrode lead 120, and it can be connected by stripping the end of the conductive wire part and welding it to the upper surface of the positive electrode lead 120. The one end of the conducting wire 140 can be bent in order to make it parallel to the upper surface of the positive electrode lead 120 so that increase the contacting length with the upper surface of the positive electrode lead 120.

The temperature-sensitive part 150 may be electrically connected to the other end of the conducting wire 140. The temperature-sensitive part 150 not only changes its shape based on the temperature, but it can also be made out of conductive metal in order to flows electricity by having other end of the conducting wire 140 connected. The temperature-sensitive part 150 is a part where its shape changes by the heat transferred from the electrode assembly 110, and most part of the temperature-sensitive part 150, with the exception of the part close to the negative electrode lead 130, can be placed to be connected to the upper surface of the electrode assembly 110.

The voltage measurer 160 electrically connects to the middle of conducting wire 140. That is, the voltage measurer 160 can have a wire connection terminal on both ends. Once the conducting wire 140 has one end connect to the positive electrode lead 120 and the other end connect to the temperature-sensitive part 150 that is placed to have the other end touch the upper surface of the electrode assembly 110, the voltage measurer 160 may be positioned to be spaced apart from the electrode assembly 110 instead of being positioned above the electrode assembly 110.

The controller 190 may halt the charging of the electrode assembly 110 if the voltage measured by the voltage measurer 160 exceeds the predetermined voltage value. When charging occurs by having electrical power connected to the positive electrode lead 120 and the negative electrode lead 130 of the electrode assembly 110, heat is generated from the electrode assembly 110. The temperature-sensitive part 150 may receive heat through conduction because it is in contact with the upper surface of the electrode assembly 110. When the temperature-sensitive part 150 receives heat and rise in temperature, the temperature sensitive part 150 at the end of the negative electrode lead 130 is transformed and can be connected to the negative electrode lead 130 above certain temperature.

In addition, the voltage measurer 160 measures voltage nonstop during the charging process, and the measured voltage value is zero before the temperature-sensitive part 150 including a shape memory alloy connects to the negative electrode lead 130. Once the temperature-sensitive part 150 connects to the negative electrode lead 130, the voltage of the electrode assembly 110 charged up to that point is measured. The controller 190 can halt the charging process of the electrode assembly 110 if the voltage measured by the voltage measurer 160 is a predetermined value slightly greater than zero, for example, 4.2 to 4.5V or 4.2 to 4.3V. Therefore, it can prevent the secondary battery from swelling, where battery gets inflated due to overcharging or igniting.

Meanwhile, the temperature-sensitive part 150 receives heat from the electrode assembly 110, is transformed in the temperature of 80 to 100° C., and may be connecting to the negative electrode lead 130. The temperature-sensitive part 150 does not connect to the negative electrode lead 130 even if its shape gets transformed in temperature between room temperature and 80° C., and once it gets to the 80 to 100° C. range, the temperature-sensitive part 150 is transformed and connected to the negative electrode lead 130.

A shape memory alloy is an alloy with a property of returning to a state before transformation when it is heated up even after changing in shape. The temperature-sensitive part 150 has its original form shaped as illustrated in FIG. 3, and may be manufactured by pressing to a rectangular plate form in room temperature. When the temperature-sensitive part 150 gets heated up to 80 to 100° C., it gets transformed to a bent form, and can be connected to the negative electrode lead 130.

In addition, the temperature-sensitive part 150 can be made of a Ni—Ti alloy. Typical examples of shape memory alloy are a Ni—Ti alloy and a Cu—Zn—Al alloy. While the Ni—Ti alloy has a disadvantage of being expensive, it is better than the Cu—Zn—Al alloy by having a great shape recovery capacity and processability.

The present specification describes the conducting wire 140 being connected to the positive electrode lead 120 and the temperature-sensitive part 150 being transformed and connected to the negative electrode lead 130, but the conducting wire 140 may be connected to the negative electrode lead 130 and the temperature-sensitive part 150 may be transformed and connected to the positive electrode lead 120.

The secondary battery according to First Embodiment of the present invention, overcharging can be prevented in advance when charging is halted if voltage is measured by the temperature-sensitive part and the voltage measurer.

### Second Embodiment

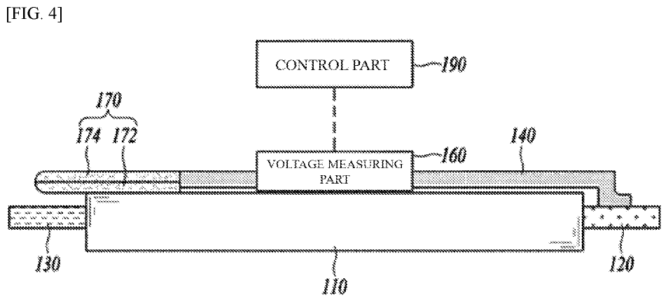

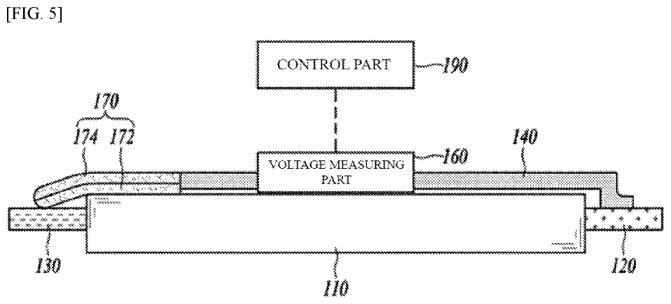

FIG. 4 is a front view schematically showing the composition of the secondary battery according to Second Embodiment of the present invention, and FIG. 5 is a front view showing a state where a bimetal, which is the temperature-sensitive part of FIG. 4, is transformed and connected to the negative electrode lead.

The secondary battery according to Second Embodiment of the present invention includes an electrode assembly 110 that has a positive electrode lead 120 and a negative electrode lead 130 on both ends, a conducting wire 140 where one end electrically connects to the positive electrode lead, a temperature-sensitive part 170 that electrically connects to the other end of the conducting wire that is opposed to the end electrically connected to the positive electrode lead and at least a part of it contacts with the electrode assembly 110, a voltage measurer 160 that electrically connects to the middle of the conducting wire, and a controller 190 that halts the electrode assembly 110 from charging by measuring voltage value greater than the predetermined value when the temperature-sensitive part 170 that includes a bimetal changes the shape and connected to the negative electrode lead 130.

The secondary battery according to Second Embodiment is different from the secondary battery according to First Embodiment in that the temperature-sensitive part 170 includes a bimetal instead of a shape memory alloy. Therefore, the following description mainly explains the temperature-sensitive part 170 that includes a bimetal.

The temperature-sensitive part 170 can be electrically connected to the other end of the conducting wire 140, which has its one end connected to the positive electrode lead 120. When the electrode assembly 110 is being charged, the temperature sensitive part 170 may receive heat from the electrode assembly 110 so that transformed and connected to the negative electrode lead. The temperature-sensitive part 170 may be positioned so that at least a part of it is in contact with the electrode assembly 110 so as to be it can receive heat from the electrode assembly 110 due to conduction.

A bimetal is made by stacking two separate thin metal sheets and welding them together to make one band, and using the fact that each metal has its own coefficient of expansion, the metal bends to one side by having different length of expansion depending on the changing temperature.

The temperature-sensitive part 170 that includes such bimetal may connect to the negative electrode lead 130 by receiving heat from the electrode assembly 110 and getting transformed in the temperature of 80 to 100° C. Depending on the coefficient of expansion and form of the two sound metals, the temperature sensitive part 170 can be manufactured to connect to the negative electrode lead 130 by being transformed at the temperature of 80 to 100° C. 80 to 100° C. can be seen as temperature range that is right before overcharging occurs in secondary batteries, especially in Li-ion batteries.

According to an exemplary embodiment, the temperature-sensitive part 170 may include a first metal 172 composed of Nickel-Iron alloy, a second metal 174 composed of an alloy of Nickel-Manganese-Iron, an alloy of Nickel-Molybdenum-Iron, or an alloy of Nickel-Manganese-Copper. Here, the first metal 172 is a metal that has smaller coefficient of expansion compared to the second metal 174, and it can be formed as an alloy consisting of Nickel and Iron. In addition, the second metal 174 is a metal that has bigger coefficient of expansion compared to the first metal 172, and it can be composed of a Nickel-Manganese-Iron alloy, a Nickel-Molybdenum-Iron alloy, or a Nickel-Manganese-Copper alloy.

While the temperature-sensitive part 170 is illustrated as being placed on the upper surface of the electrode assembly 110 in FIG. 3 and FIG. 4, the temperature-sensitive part 170 including a bimetal can be placed on the under surface of the electrode assembly 110. Since the second metal 174 is a metal that has bigger coefficient of expansion compared to the first metal 172, it is more efficient for the second metal 174 to be in contact with the electrode assembly 110, and directly receive heat from it.

### Third Embodiment

Next will be an explanation of a method for controlling charging of the secondary battery according to the present invention by referring to the figures.

First, connect electrical power to the positive electrode lead 120 and the negative electrode lead 130 of the electrode assembly 110, and begin charging by supplying electricity.

Then, measure voltage using the voltage measurer 160, which is connected to the middle of conducting wire where one end is connected to the positive electrode lead 120 and the other end is connected to the temperature-sensitive part 150 or 170.

Here, the temperature-sensitive part 150 or 170 may include a shape memory alloy of First Embodiment or a bimetal of Second Embodiment. The temperature-sensitive part 170 that includes a shape memory alloy can be connected to the negative electrode lead 130 as its shape gets transformed by the heat received from the electrode assembly having at least a part of it contact with the electrode assembly 110. The temperature-sensitive part 170 that includes a bimetal has at least its part in contact with the electrode assembly 110 and can be connected to the negative electrode lead 130 by transforming due to the heat received from the electrode assembly.

In addition, the voltage measurer 160 can continuously measure voltage once charging is started and can send voltage signal to the controller 190.

Lastly, by having the temperature-sensitive part 150 or 170 changes its shape and connects to the negative electrode lead 130, the electrode assembly 110 halts charging if the voltage value measured by the voltage measurer 160 is greater than the predetermined value.

Specifically, during the charging of the electrode assembly 110, the temperature-sensitive part 150 or 170 receives heat from the electrode assembly 110 and gets transformed, and once it gets to the temperature of 80 to 100° C., it can be connected to the negative electrode lead 130. Accordingly, the voltage value measured at the voltage measurer 160 increases from zero to a value greater than a predetermined value, and the controller 190 can halt charging of electrode assembly 110 when this voltage signal is received.

While the present invention has been described in connection with what is presently considered to be practical exemplary embodiments, various changes, modifications, and replacements may be made by those skilled in the art without departing from the essential characteristics of the present invention by attaching, changing, deleting, or adding components, and they may also encompass all modifications and equivalents that fall within the scope of the appended claims.

### DESCRIPTION OF SYMBOLS

100: SECONDARY BATTERY
110: ELECTRODE ASSEMBLY
120: POSITIVE ELECTRODE LEAD
130: NEGATIVE ELECTRODE LEAD
140: CONDUCTING WIRE
150/170: TEMPERATURE-SENSITIVE PART
160: VOLTAGE MEASURER
172: FIRST METAL
174: SECOND METAL
190: CONTROLLER

1. A secondary battery comprising:
an electrode assembly having a positive electrode lead and a negative electrode lead on opposite ends of the electrode assembly;
a conducting wire having a first end electrically connected to the positive electrode lead; and
a voltage measurer being electrically connected to a middle of the conducting wire; and
a temperature-sensitive part at a second end of the conducting wire,
wherein the conducting wire electrically connects the positive electrode lead and the negative electrode lead according to temperature conditions.

2. The secondary battery of claim 1, wherein the temperature-sensitive part electrically connects the positive electrode lead and the negative electrode lead by changes in shape when it is exposed to temperature between 70° C. and 100° C.

3. The secondary battery of claim 1, wherein the temperature-sensitive part contains a shape memory alloy comprising a nickel-titanium alloy.

4. The secondary battery of claim 1, wherein the temperature-sensitive part contains a bimetal comprising:
a first metal consisting of a nickel-iron alloy; and
a second metal consisting of a nickel-manganese-iron alloy, a nickel-molybdenum-iron alloy, or a nickel-manganese-copper.

5. The secondary battery of claim 1, wherein the voltage measurer measures the voltage between the positive electrode lead and the negative electrode lead when the conducting wire connects to the negative electrode lead due to the change in shape of the temperature-sensitive part.

6. The secondary battery of claim 1, wherein the secondary battery contains a controller that is electrically connected to the voltage measurer and receives voltage value measured by the voltage measurer.

7. The secondary battery of claim 6,
wherein the controller halts the charging of the secondary battery if the voltage value received from the voltage measurer is greater than or equal to a predetermined value.

8. A charging method of a secondary battery comprising:
charging a secondary battery according to claim 1 by supplying electric power;
measuring a voltage by the voltage measurer when the temperature-sensitive part of the conducting wire provided in the secondary battery electrically connects to the negative electrode lead; and
halting the charging of the secondary battery if the voltage value received from the voltage measurer is greater than or equal to the predetermined value.

9. The charging method of the secondary battery of claim 8, wherein the temperature-sensitive part electrically connects the positive electrode lead and the negative electrode lead by changes in shape when exposed to temperature between 70° C. and 100° C.

10. The charging method of the secondary battery of claim 8, wherein the temperature-sensitive part contains a shape memory alloy comprising a Nickel-Titanium alloy.

11. The charging method of the secondary battery of claim 8, wherein the temperature-sensitive part contains a bimetal comprising:
a first metal consisting of a nickel-iron alloy; and
a second metal consisting of a nickel-manganese-iron alloy, a nickel-molybdenum-iron alloy, or a nickel-manganese-copper.
